(19) United States
(12) Patent Application Publication
(10) Pub. No.: US 2026/0359786 A1
(43) Pub. Date: Nov. 12, 2026

(54) REUSABLE MODULAR EQUIPMENT BEHAVIOUR CATALOGUE GENERATING APPARATUS AND METHOD

(71) Applicant: ELECTRONICS AND TELECOMMUNICATIONS RESEARCH INSTITUTE, Daejeon (KR)

(72) Inventors: Young Ae CHUN, Daejeon (KR); Hojin PARK, Daejeon (KR); Hark Jin LEE, Daejeon (KR); Kang-Woo LEE, Daejeon (KR); Seung-Woog JUNG, Daejeon (KR)

(21) Appl. No.: 19/671,623

(22) Filed: May 8, 2026

(30) Foreign Application Priority Data
May 9, 2025 (KR) 10-2025-0060599
May 6, 2026 (KR) 10-2026-0081473

(51) Int. Cl. G06Q 10/087

(52) U.S. Cl. CPC G06Q 10/0877

(57) ABSTRACT

According to an embodiment, a reusable modular equipment behaviour catalogue generating apparatus comprises a processor; and a memory storing instructions executed by the processor, wherein the processor, by executing the instructions, collects behaviour information including an operation condition, a state transition, and a functional execution procedure of equipment, extracts the behaviour information by separating the behaviour information into static data and dynamic data, derives a state, a state transition, and an external interface of the equipment based on the static data and the dynamic data, structures the behaviour information including the derived state, the state transition, and the external interface on a module-by-module basis, and generates a reusable Equipment Behaviour Catalogue (EBC) by combining the structured behaviour information.

### CROSS-REFERENCE TO RELATED APPLICATIONS

The present application claims priority under 35 U.S.C. 119(a) to Korean patent application number 10-2025-0060599 filed on May 9, 2025, and Korean patent application number 10-2026-0081473 filed on May 6, 2026, which are incorporated herein by reference in its entirety.

### TECHNICAL FIELD

The present disclosure relates to an apparatus and a method for generating a reusable Equipment Behaviour Catalogue (EBC).

### BACKGROUND

Recently, with the proliferation of virtual production system (VPS) based on smart manufacturing and digital twins, there is an increasing demand to precisely represent actual production facilities in a digital environment and perform simulations based such representations.

In the virtual production system, equipment catalogues including physical specifications, configuration information, and operating conditions are utilized, but conventional equipment catalogues have a limitation in that they do not sufficiently reflect actual operations of equipment because the conventional equipment catalogues mainly include static information focused on a property.

In particular, behaviour information including operation conditions, a state transition, a functional execution procedure, and an operation result of the equipment significantly affects the accuracy and reliability of the simulation, but such behaviour information is often not systematically defined or standardized.

Accordingly, research on Equipment Behaviour Catalogue (EBC) including the behaviour information of the equipment is ongoing, and attempts are being made to structure states and operations of the equipment through the international standard ISO 16400 series.

However, existing equipment behaviour catalogues are often designed to be dependent on specific equipment or specific scenarios, making it difficult to reuse them for other equipment or similar processes.

Furthermore, the process of configuring the behaviour information of the equipment relies on manualprocesses, requiring a significant amount of time and cost to generate the catalogue.

Furthermore, if elements including a state, a state transition, and an external interface constituting the operation of the equipment are defined without consistent criteria, analyzing interactions among pieces of equipment or integrating systems becomes difficult.

In particular, a modular structure capable of flexibly reconfiguring or expanding equipment behaviour information according to various manufacturing environments and simulation purposes is lacking, resulting in limited utilization in digital twin-based applications.

### SUMMARY

An embodiment provides a method and an apparatus for systematically structuring behaviour information including an operation condition, a state transition, a functional execution procedure, and an external interface of equipment, defining the behaviour information on a module-by-module basis, and generating a reusable Equipment Behaviour Catalogue (EBC).

Furthermore, the embodiment allows equipment behaviour information to be efficiently derived by collecting, analyzing, and classifying equipment-related information including equipment-related data of various formats.

Furthermore, the embodiment provides an expandable and reusable structure for various equipment and scenarios by subdividing components constituting the equipment based on independence, functionality, replaceability, and connectivity criteria, and modularizing the behaviour information of the equipment based the subdivided components.

Furthermore, the embodiment improves simulation accuracy and utilization in virtual production system and digital twin environments by defining a behaviour model including the state, the state transition, and the external interface of the equipment as a standardized structure.

Furthermore, the embodiment improves the efficiency of equipment modeling and simulation by generating the equipment behaviour catalogue in the form of a template and an instance, and allowing them to be applied and verified in various execution environments.

Furthermore, the embodiment allows the equipment behaviour information to be extracted and structured from the equipment-related data by utilizing one or more information processing techniques including Natural Language Processing (NLP), rule-based analysis, or machine learning-based processing techniques.

Furthermore, the embodiment allows the generated equipment behaviour catalogue to be applicable to various smart manufacturing systems including a digital twin, a virtual commissioning, and a production process simulation.

The problem to be solved by the present disclosure is not limited to those mentioned above, and other unmentioned problems to be solved may be clearly understood by those skilled in the art to which the present disclosure pertains from the following description.

A reusable modular equipment behaviour catalogue generating apparatus according to a first aspect includes a processor; and a memory storing instructions executed by the processor, wherein the processor, by executing the instructions, collects behaviour information including an operation condition, a state transition, and a functional execution procedure of equipment, extracts the behaviour information by separating the behaviour information into static data and dynamic data, derives a state, a state transition, and an external interface of the equipment based on the static data and the dynamic data, structures behaviour information including the derived states, state transitions, and external interfaces on a module-by-module basis, and generates a reusable Equipment Behaviour Catalogue (EBC) by combining the structured behaviour information.

A method for generating a reusable modular equipment behaviour catalogue performed by a computing device according to a second aspect comprises collecting behaviour information of equipment; extracting the behaviour information by separating the behaviour information into static data and dynamic data; deriving a state, a state transition, and an external interface based on the static data and the dynamic data; structuring the derived information on a module-by-module basis; and generating a reusable equipment behaviour catalogue by combining the modules.

A non-transitory computer-readable storage medium storing a computer program according to a third aspect allows the processor to perform a method for generating a reusable modular equipment behaviour catalogue including, by the processor executing at least one instruction of the computer program, collecting behaviour information of equipment; extracting the behaviour information by separating the behaviour information into static data and dynamic data; deriving a state, a state transition, and an external interface based on the static data and the dynamic data; structuring the derived information into modules; and generating a reusable equipment behaviour catalogue by combining the modules.

A computer program stored in a non-transitory computer-readable storage medium according to a fourth aspect allows the processor to perform a method for generating a reusable modular equipment behaviour catalogue including, by the processor executing at least one instruction of the computer program, collecting behaviour information of equipment; extracting the behaviour information by separating the behaviour information into static data and dynamic data; deriving a state, a state transition, and an external interface based on the static data and the dynamic data; structuring the derived information into modules; and generating a reusable equipment behaviour catalogue by combining the modules.

According to the above aspects, a reusable equipment behaviour catalogue in various manufacturing simulation environments and virtual production systems may be provided by systematically structuring behaviour information including an operation condition, a state transition, a functional execution procedure, and an external interface of equipment, and configuring them on a module-by-module basis.

Accordingly, an accurate representation of the equipment operation is enabled and the reliability of the simulation may be improved by extracting the behaviour information of the equipment by dividing the behaviour information into the static data and the dynamic data, and deriving the state, the state transition, and the interface based thereon.

Furthermore, an expandable and flexible model configuration is enabled for various equipment and process environments by subdividing the components of the equipment based on independence, functionality, replaceability, and connectivity criteria and modularizing them.

Furthermore, since the equipment behaviour information may be efficiently generated by collecting, analyzing, and classifying various forms of equipment-related information including equipment-related data, time and cost may be reduced compared to the conventional method depending on manual work.

Furthermore, since the equipment behaviour catalogue may be generated in the form of a template and an instance and utilized in various execution environments, the efficiency and consistency of equipment modeling and simulation construction may be improved.

Furthermore, the generated equipment behaviour catalogue may be utilized for productivity prediction, process optimization, and maintenance strategy establishment by being applied to the digital twin, the virtual commissioning, and the production process simulation environments.

Furthermore, since the equipment behaviour information may be selectively combined or reconfigured through the modular structure, a rapid response to various scenarios and a system integration become easy.

### BRIEF DESCRIPTION OF THE DRAWINGS

FIG. 1 is a block diagram of a computing device capable of being used as a reusable modular equipment behaviour catalogue generating apparatus according to a first aspect of the present disclosure.

FIG. 2 is a diagram showing a structure of an equipment behaviour catalogue according to an embodiment of the present disclosure.

FIG. 3 is a block diagram showing a reusable modular equipment behaviour catalogue generating procedure capable of being performed by the reusable modular equipment behaviour catalogue generating apparatus according to an embodiment of the present disclosure.

FIGS. 4A and 4B are flowcharts for explaining a method for generating a reusable modular equipment behaviour catalogue according to a second aspect of the present disclosure.

### DETAILED DESCRIPTION OF THE INVENTION

Advantages and features of the present disclosure, and methods for achieving them will become clear with reference to the embodiments described below in conjunction with the accompanying drawings. However, the present disclosure is not limited to the embodiments disclosed below, but may be implemented in various different forms, and the present embodiments are merely provided to complete the disclosure of the present disclosure and to completely inform those skilled in the art of the scope of the disclosure, and the present disclosure is defined by the scope of the claims.

Terms used in this specification will be briefly described, and the present disclosure will be described in detail.

Terms used in the present disclosure have been selected from general terms currently widely used as much as possible while considering functions in the present disclosure, but these may vary depending on the intention or precedent of a person skilled in the art, the emergence of new technologies, and the like. Furthermore, in a specific case, there are also terms arbitrarily selected by the applicant, and in this case, the meaning thereof will be described in detail in the corresponding description part of the disclosure. Therefore, the terms used in the present disclosure should be defined based on the meaning of the terms and the overall contents of the present disclosure, rather than simply the names of the terms.

Throughout the specification, when a part “includes” a certain component, the inclusion means that the part does not exclude other components but may further include other components unless specifically stated to the contrary.

Furthermore, the term ‘unit’ used in the specification means a software or hardware component such as FPGA or ASIC, and the ‘unit’ performs certain roles. However, the term ‘unit’ is not meant to be limited to software or hardware. The ‘unit’ may be arranged to reside in an addressable storage medium, and may be arranged to reproduce one or more processor units. Therefore, as an example, the ‘unit’ includes components including software components, object-oriented software components, class components, and task components, and processes, functions, attributes, procedures, subroutines, segments of program codes, drivers, firmware, microcodes, circuits, data, databases, data structures, tables, arrays, and variables. Functions provided within the components and the ‘unit’s may be combined into a smaller number of components and ‘unit’s or further separated into additional components and ‘unit’s.

Hereinafter, embodiments of the present disclosure will be described in detail with reference to the accompanying drawings so that those skilled in the art to which the present disclosure pertains may easily implement them. And in the drawings, parts irrelevant to the description are omitted to clearly describe the present disclosure.

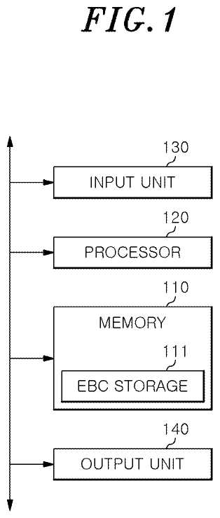

FIG. 1 is a block diagram of a computing device capable of being used as a reusable modular equipment behaviour catalogue generating apparatus according to a first aspect of the present disclosure. In the following description, the computing device will be referred to as a reusable modular equipment behaviour catalogue generating apparatus 100.

The reusable modular equipment behaviour catalogue generating apparatus 100 includes a memory 110 and a processor 120, and may further include an input unit 130 and/or an output unit 140.

The memory 110 includes an EBC storage 111 storing the Equipment Behaviour Catalogue (EBC), and the processor 120 may perform each operation of the method for generating the reusable modular equipment behaviour catalogue according to the embodiment by executing the instructions of the computer program stored in the memory 110. That is, the processor 120 generates the equipment behaviour catalogue in a reusable form by structuring function and state information of the equipment on a manufacturing system and a digital twin environment, for example, a virtual production system (VPS).

Furthermore, the reusable modular equipment behaviour catalogue generating apparatus 100 may receive input data through the input unit 130 including a user interface or an external system interface (API, message queue, data stream, etc.), and the input unit 130 provides this to the processor 120. And, the reusable modular equipment behaviour catalogue generating apparatus 100 may output the equipment behaviour catalogue or an intermediate processing result generated by the processor 120 to an external system, etc., through the output unit 140. In one embodiment, an input/output interface for the input unit 130 and/or the output unit 140 may be implemented through a communication protocol including a web-based application program interface, a standard communication interface for data exchange between industrial equipment, and a lightweight message-based data transmission protocol.

The processor 120 generates a modular behaviour information catalogue applicable to a simulation, a virtual operation, and a predictive analysis by performing the method for generating the reusable modular equipment behaviour catalogue to express operation characteristics, state transitions, functional execution conditions, etc., in a digital form for various equipment or assets, and to configure them to be reusable for various purposes by defining them by configuration units.

Furthermore, a modular equipment behaviour catalogue generating process may generate the equipment behaviour catalogue by collecting the behaviour information of the equipment, extracting it by separating it into static data and dynamic data, deriving a state, a state transition, and an external interface, structuring them on a module-by-module basis, and then combining the modules. Throughout the present specification, a “module” may be implemented in hardware, software, or firmware, and may include a logical unit or a physical component performing one or more functions.

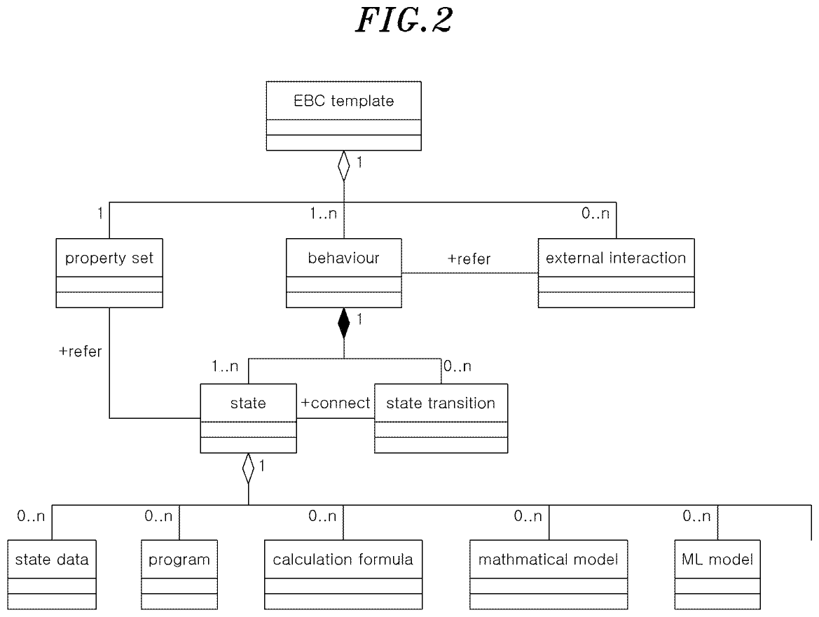

As shown in FIG. 2, the equipment behaviour catalogue may include a property of the equipment, a behaviour including a state and a state transition, and interaction information with external equipment. Furthermore, the equipment behaviour catalogue may include version information (version), a generation history (history), and a change history (change log), thereby ensuring traceability and reproducibility of the catalogue.

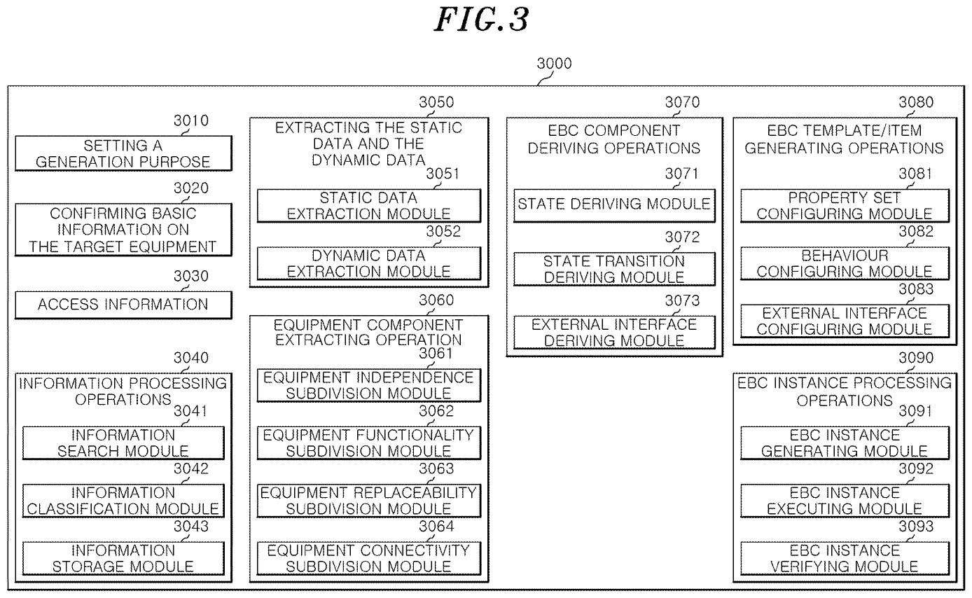

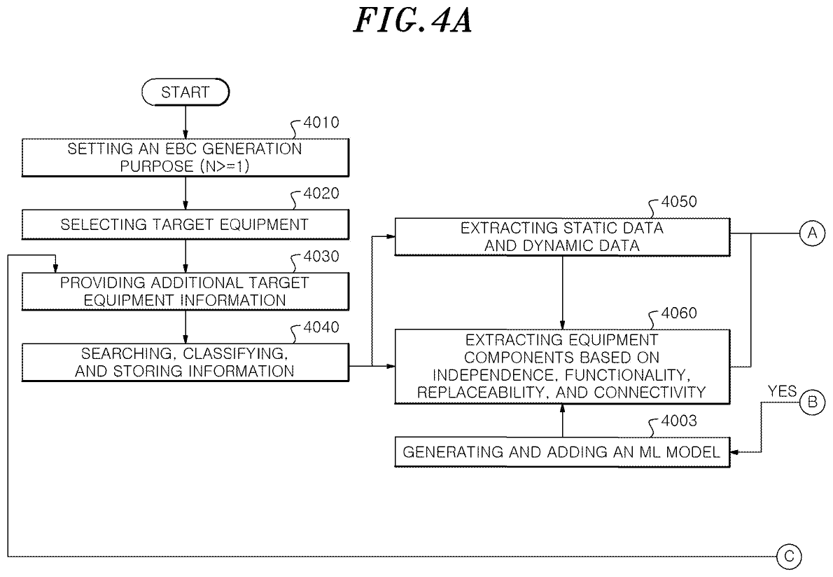

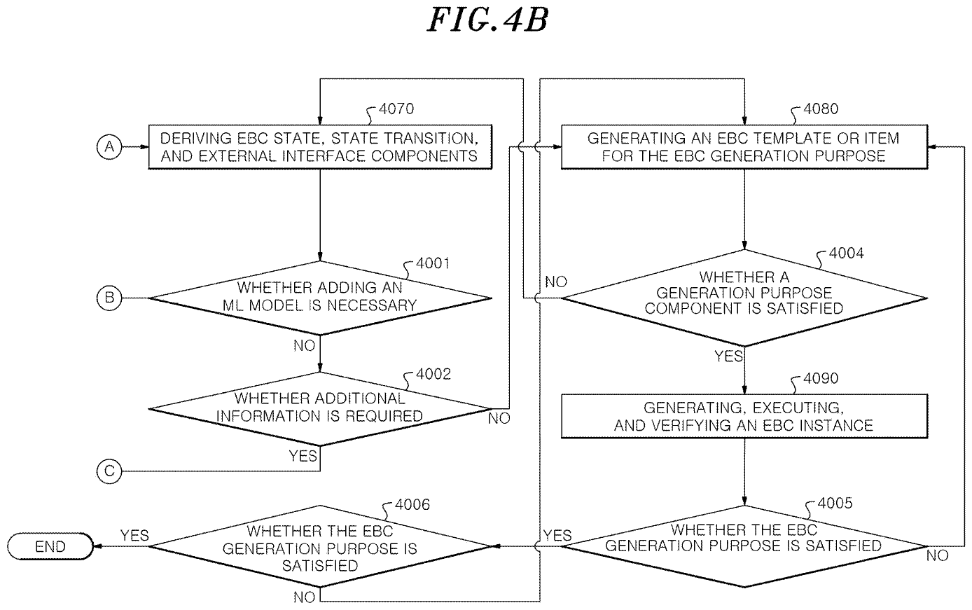

FIG. 3 is a block diagram showing the reusable modular equipment behaviour catalogue generating procedure capable of being performed by the reusable modular equipment behaviour catalogue generating apparatus according to an embodiment of the present disclosure, and FIGS. 4A and 4B are flowcharts for explaining the method for generating the reusable modular equipment behaviour catalogue according to a second aspect of the present disclosure.

Referring to FIGS. 3, 4A and 4B, an equipment behaviour catalogue generating procedure 3000 begins with an operation 3010, 4010 of setting a generation purpose of the equipment behaviour catalogue, and the generation purpose may be set according to various utilization purposes including performance analysis, process optimization, anomaly prediction, or maintenance planning of the equipment. For example, a purpose including collecting behaviour information for predicting a tool replacement time of a CNC machine may be set. The generation purpose may be input through a system or separately defined, and a range and a structuring method of the behaviour information to be collected are determined according to the generation purpose.

Furthermore, a priority, an importance, or an application range of the purpose may be set through a user intervention when setting the generation purpose, and an appropriate generation purpose may be proposed through an automatic recommendation algorithm.

Next, an operation 3020, 4020 of confirming basic information on the target equipment is performed, and the target equipment information includes identification information including an equipment name, a model name, and a manufacturer, and may be secured through a user input or an interworking with an external system including an enterprise resource and production process management system.

Subsequently, information for accessing technical documents and operation information related to the target equipment is provided, and the access information includes metadata including a storage location, a data format, and an author 3030, 4030. A user may directly designate the access information or secure it through a search or inference-based request, and through this, the behaviour information including the operation condition, the state transition, and the functional execution procedure of the equipment may be collected from the equipment-related information.

Such access information may be referenced in subsequent information searching, classifying, and storing operations.

In this case, the behaviour information may be defined as structurable information including operating conditions of the equipment, transition relationships between states, and procedures for performing each function.

Furthermore, a data quality management procedure for evaluating reliability, currency, and a source of data may be performed in an information collection process, and data with low reliability may be filtered or separately displayed.

Information processing operations 3040, 4040 of searching, classifying, and storing the equipment-related information are performed based on the access information. These searching, classifying, and storing functions may be implemented by an information search module 3041, an information classification module 3042, and an information storage module 3043.

The information search module 3041 performs an information search operation of searching for the equipment-related information targeting various heterogeneous data including a document file, an image file, a video file, an audio file, a 3D model and design drawing data file, a control program file (e.g., a control system file for industrial automation), and a data file (e.g., a delimiter-based text data format, a structured data representation format, etc.). The search in this information search operation is performed based on metadata conditions including a pre-secured storage location, a file format, and an author, and the searched information is transferred to the information classification module 3042.

The information classification module 3042 performs an information classification operation of classifying the searched information according to equipment-centric classification criteria while maintaining an original form. The classification criteria may include equipment basic information, installation information, operation information, maintenance information, anomaly response information, quality and performance information, energy information, and operation history information. Information of various formats including an image, a video, an audio, and a document may be classified as it is without processing by being classified by category according to the classification criteria.

The information storage module 3043 performs an information storage operation of storing the classified information in a local or server-based storage, or storing a path and metadata of the corresponding information if stored in an external system, and enabling a remote access. When storing, information including a classification item, an original location, a file format, a creation date, and a version may be recorded together to facilitate history management and reuse.

Furthermore, an access control policy may be applied when storing the information, and a data access range may be limited according to a user authority or an encrypted storage method may be applied.

Next, operations 3050, 4050 of extracting the static data and the dynamic data based on the stored information are performed. These extraction functions may be implemented by a static data extraction module 3051 and a dynamic data extraction module 3052.

The static data includes unchanging information including physical specifications, installation conditions, and environmental conditions of the equipment. For example, an equipment name, a model name, a manufacturer, external dimensions, a power specification, an installation condition, a usage environmental condition, etc., may be included.

The dynamic data includes information changing according to time or conditions, including an operation procedure, a state transition condition, an input/output signal, an anomaly occurrence condition, and maintenance information of the equipment, and may include an operation procedure, a control flow, a mathematical formula, a control algorithm, and machine learning-based inference information. For example, the dynamic data is based on information collected from an operation manual, a maintenance guideline, an accident report, an operation log, and a sensor record, and may include an operation condition of a formula type, an algorithm definition, and a learned machine learning model result in addition to a logical sequence, a conditional statement, and a procedure flow specified in the document.

The information of the static data and the dynamic data may be converted into a structured format suitable for various application purposes including a state tracking, a predictive maintenance, and an anomaly response scenario configuration of the equipment, and integrated into the equipment behaviour catalogue.

Furthermore, a data extraction process may be performed in a real-time streaming data processing method, and the dynamic data may be updated in real time from a sensor data stream.

Next, an equipment component extracting operation 3060 of subdividing components constituting the equipment based on independence, functionality, replaceability, and connectivity criteria is performed. These equipment component extracting functions may be implemented by the equipment independence subdivision module 3061, the equipment functionality subdivision module 3062, the equipment replaceability subdivision module 3063, and the equipment connectivity subdivision module 3064.

The equipment independence subdivision module 3061 is a module determining whether specific equipment may be independently operated, or whether the specific equipment may perform functions natively without combination with an external system or other equipment. The equipment independence subdivision module evaluates a control range, a self-driving function, a standalone operability, and the like, of the equipment, and subdivides components based on a modularization level or a coupling relationship between sub-components. The classification criteria may utilize a single module (a small module or part independently performing one functional unit), a unit system (a unit system where a plurality of modules are integrated to perform one functional purpose), a service system (a dependent system supporting other systems or performing a subsidiary function), and the like.

The equipment functionality subdivision module 3062 performs a function of subdividing components based on functional roles respectively performed by the components within the equipment. For example, each component is separated and classified by functional unit by analyzing which functional unit each part or module within the equipment is responsible for, including processing, transferring, fixing, measuring, and controlling. This equipment functionality subdivision is utilized as a basis for accurately modeling an equipment operation purpose in a subsequent operation. The classification criteria may utilize a processing function (a direct processing function including material processing, cutting, and molding), a subsidiary function (a supporting function including supply, cooling, clamp, and lighting), a control function (a control-related function including a sensor, an actuator, and a control system for industrial automation), an monitoring function (a monitoring/measuring function including condition monitoring, an alarm, and a quality inspection), and the like.

The equipment replaceability subdivision module 3063 performs a function of identifying parts requiring maintenance or lifespan replacement among the components of the equipment, and subdividing the parts based on criteria including a replacement cycle of the parts, a standardization status, and an interface suitability. The module organizes a replacement information system typically required from a perspective of spare part management or early maintenance by analyzing an equipment manual, a maintenance history, a part specification document, and the like. The classification criteria may utilize a periodic replacement part (a regularly replaced part including a filter and a lubricant), an emergency replacement part (a part requiring an urgent replacement during a failure or an abnormal situation), an upgrade target part (a replaceable component for a performance improvement or a specification change), and the like.

The equipment connectivity subdivision module 3064 performs a function of analyzing how the equipment is physically and logically connected to other equipment or systems, and subdividing components of the equipment based on an external interface, a communication port, and a sensor/actuator connection structure of each component. The equipment connectivity subdivision module identifies connection information including a standard communication interface for data exchange between industrial equipment, a control system for industrial automation, an I/O port, and a mechanical interface, and provides base data for an integrated operation of the equipment and a link scenario configuration between systems. The classification criteria may utilize a physical connection (a substantial connection element including a power supply, hydraulic pressure, pneumatic pressure, and piping), a communication module (a data communication-related configuration including Ethernet, Fieldbus, and serial communication), an event/signal interface (an interface element including external signal processing, a sensor trigger, and event reception), and the like.

Each equipment component subdividing function may be performed as a part of the method for generating the equipment behaviour catalogue, and may be included as a pre-processing operation for defining the equipment components on a module-by-module basis.

Each module subdivides the components based on structural and functional characteristics, a maintenance perspective, and an external connection structure of the equipment, and defines a modularizable equipment configuration unit through this.

Furthermore, interoperability may be secured by referring to an international standard model (e.g., a standard metamodel for a digital representation of an asset, a standard communication interface model for data exchange between industrial equipment, etc.) when defining the components.

Next, processes for EBC component deriving operations 3070, 4070 of deriving the state, the state transition, and the external interface of the equipment based on the static data, the dynamic data, and the equipment component information, and converting them into a digital representation structure of the equipment behaviour catalogue are performed. These deriving functions may be implemented by a state deriving module 3071, a state transition deriving module 3072, and an external interface deriving module 3073.

The state includes a state entry operation, a state maintenance operation, and a state exit operation, and works performed in each state may be expressed in the form of a procedure, a condition, a formula, an algorithm, or a machine learning result.

The state deriving module 3071 performs a function of defining various states occurring during an equipment operation process and deriving an action related to an entry condition, an operation within the state, and a state exit condition of each state.

The state transition includes a starting state (a state where the transition begins), an arrival state (a state reached after the transition), a transition condition (input signal, time elapse, sensor value, event reception, etc.), and a transition type (sequential transition, conditional branch, event-based transition, etc.), and is defined in various forms including a conditional branch and an event-based transition. A transition definition is derived from an operation procedure, a control sequence, and a control program flow, and may be utilized to configure an action flowchart on the equipment behaviour catalogue.

The state transition deriving module 3072 performs a function of configuring a state transition structure by identifying a transition condition, a flow, and a directionality between each state defined in the state deriving module.

The external interface defines a signal transmission and reception structure between the equipment and the external system, and includes a signal direction, identification information of a connected equipment or system, and an interface type (digital/analog I/O, communication-based, event-based, etc.).

The external interface deriving module 3073 performs a function of deriving an information transmission and reception structure and an interface path between the equipment and the external system, other equipment, or a control device.

Furthermore, an error state, an exception handling flow, and a recovery scenario may be additionally defined during the state transition and interface deriving process.

Next, operations 3080, 4080 of generating components of the equipment behaviour catalogue based on the derived state, state transition, and external interface information are performed. In this operation, a property set including static properties of the equipment, a behaviour including the state and the state transition, and a structure including the external interface are defined, and the components may be represented in a structured data representation format or a standard metamodel format for a digital representation of an asset.

The components are defined on a module-by-module basis to be selectively combinable for different equipment or scenarios, and may generate the reusable equipment behaviour catalogue by combining the structured behaviour information. Furthermore, the structured module has an extensible structure, and if new equipment or a new function is added, then a new module may be additionally coupled while reusing the existing module.

Subsequently, an EBC template/item generating operation of generating one or more EBC templates or items according to the set generation purpose may be performed. Herein, each template includes property, behaviour, and interface information corresponding to a specific purpose. Herein, an EBC template or item including the property set, the behaviour, and the external interface may be generated based on the structured behaviour information.

These EBC template/item generating operations 3080, 4080 may be repeatedly performed for a plurality of generation purposes, and a data extracting and component deriving operation may be reperformed according to whether the generation purpose is satisfied. These EBC template/item generating functions may be implemented by a property set configuring module 3081, a behaviour configuring module 3082, and an external interface configuring module 3083.

The property set configuring module 3081 performs a function of organizing static characteristics, state variables, and main property values of the equipment into the property set within the equipment behaviour catalogue by structuring them. A configuration item may utilize basic information (equipment name, model name, manufacturer, etc.), specification information (size, weight, power, interface port, etc.), a state variable (real-time value or initial set value including temperature, speed, and pressure), and the like. The property set configuring module 3081 defines a property-based information structure connected to the state or the operation within the equipment behaviour catalogue.

The behaviour configuring module 3082 performs a function of generating a Behaviour Description of the equipment behaviour catalogue based on the previously derived state and state transition information. Based on the state (including Action) and the transition flow between states, a scenario per purpose (e.g., stop->run->stop) is configured, and a logical structure for each state and transition unit is converted into a standardized representation format interpretable by both human and machine, for example, a structured data format, and configured as an equipment behaviour catalogue structure. This information is used as a core execution structure of the EBC template.

The external interface configuring module 3083 performs a function of defining an external system interworking structure required in the equipment behaviour catalogue based on the derived external interface information. Items including a name, a data type, a direction (input/output), a usage condition, a communication method (e.g., a standard communication interface for data exchange between industrial equipment, a lightweight message-based data transmission protocol, etc.), and connection target equipment or system identification information of an input/output signal may be included. The external interface configuring module 3083 declaratively configures a port required to connect the equipment behaviour catalogue to actual equipment or a simulation environment.

Next, EBC instance processing operations 3090, 4090 of generating an executable EBC instance based on the generated template are performed. The instance is composed of an execution unit including input values, initial state values, and execution conditions, and may be serialized into a structured data representation format or a standard metamodel submodel format for a digital representation of an asset, or may be converted into a general-purpose programming language-based object structure.

The generated EBC instance is executed in an environment linked with a simulation environment, a digital twin platform, a testbed, or an actual control system, and a state transition flow, a condition response, an input/output signal, and an external interface operation are performed. Accordingly, the processor 120 may be programmed to execute the EBC instance in the simulation environment or an actual operation environment, and verify an execution result thereof.

Furthermore, suitability of the state transition, accuracy of an interface operation, scenario matching, and effectiveness of an exception handling are evaluated through verification of the execution result, and the EBC model may be modified, approved, or regenerated according to the verification result.

Furthermore, quantitative evaluation criteria including a performance indicator (KPI), accuracy, a response time, and a system load may be applied in a verification process.

These EBC instance processing functions may be implemented by an EBC instance generating module 3091, an EBC instance executing module 3092, and an EBC instance verifying module 3093.

The EBC instance generating module 3091 performs a function of generating an executable instance having a format and structure suitable for a specified execution environment based on the equipment behaviour catalogue structure defined in the form of the template or the item. Upon generation, an individual instance including an execution logic is configured by injecting an input value, an operation parameter, initial state information, etc. The instance may be serialized into a structured representation format or configured into a standard metamodel format for a digital representation of an asset, and may be converted into a general-purpose programming language-based object structure or a format interworkable with a simulation tool (e.g., an agent-based or discrete event simulation tool, etc.) if necessary. Therefore, the generated instance may be transmitted to various execution environments thereafter and driven.

The EBC instance executing module 3092 performs a function of executing the generated EBC instance in an actual environment or a virtual test environment to check whether logic including a state transition, an operation scenario, and an interface response defined in the EBC normally drives. An execution target environment may be a simulation tool (e.g., an agent-based or discrete event simulation tool, etc.), a digital twin platform (e.g., virtual environment-based simulation, a digital twin implementation platform), a testbed or an actual control system interworking environment, and actions including a transition flow between states, a condition response, an input/output signal generation, and an external interface call may be observed or recorded as a log during execution, and this operation acts as a core processing operation for verifying logical consistency and executability of the EBC instance.

The EBC instance verifying module 3093 performs a function of analyzing an operation result of the executed EBC instance to evaluate whether a state and an operation flow defined in the model are normally implemented. Verification items include suitability of state entry and state transition, accuracy of external interface transmission and reception operations, whether the execution result matches an expected operation scenario, effectiveness of a response processing flow if a warning, an error, or an exception occurs, and a verification result is configured in the form of a log file, an execution report, an abnormal state list, etc., and is ultimately utilized as a criterion for determining whether to review, approve, or modify the EBC model.

Furthermore, the information processing operation 3040, the data extracting operation 3050, and the EBC component deriving operation 3070 may be performed utilizing one or more information processing techniques including Natural Language Processing (NLP), rule-based analysis, or a machine learning-based model to extract information from the equipment-related data. In particular, information may be extracted from technical documents and converted into a structured data representation format through a function calling method and a structured data generation technique using a large language model (e.g., a large-capacity data-based language understanding and generation model).

Furthermore, a rule-based parser, a machine learning-based classifier (e.g., a supervised learning-based classification algorithm), an information extraction framework (e.g., an information processing framework for natural language processing and automated machine learning), and a domain knowledge-based ontology may be applied in parallel.

Furthermore, in the data extracting operation 3050 and the equipment component extracting operation 3060, a machine learning model may be generated and utilized for failure prediction, anomaly detection, and maintenance prediction, and if necessary, EBC completeness may be improved through information supplementation and repeated performance.

Furthermore, at least a part of the information processing operation 3040, the data extracting operation 3050, the EBC component deriving operation 3070, and the EBC template/item generating operation 3080 performed in the equipment behaviour catalogue generating process according to an embodiment of the present disclosure may be performed utilizing various intelligent information processing techniques to effectively extract and structure meaningful information from the technical document or the equipment-related data. In one embodiment, information related to the state, the state transition, and the external interface of the equipment may be extracted and converted into a structured data format by applying function calling, Natural Language Processing (NLP), structured data generation techniques, etc., using a large language model (e.g., a large-capacity data-based language understanding and generation model), and the data may be managed by being included in an upper metamodel structure including a standard metamodel for a digital representation of an asset.

Furthermore, this method is merely an implementation example, and the present disclosure is not limited to a specific information processing method. For example, various information processing techniques including a rule-based parser (e.g., keyword search, regular expression, tree-based analysis, etc.), a machine learning-based classifier (e.g., supervised learning-based classification algorithm), an information extraction framework (e.g., an information processing framework for natural language processing and automated machine learning), or an expert definition-based mapping rule and domain knowledge ontology linkage method may be applied individually or in combination.

In particular, since the information processing operation 3040, the data extracting operation 3050, the EBC component deriving operation 3070, the EBC template/item generating operation 3080, and the EBC instance processing operation 3090 all include a process of deriving specific information from the equipment-related data, they may be automated by the large-capacity data-based language understanding and generation model or an equivalent function processing module equivalent thereto.

More specifically, upon setting an EBC generation purpose and securing equipment information, a scope and a characteristic of an equipment behaviour catalogue generated thereafter are determined according to one or more generation purposes defined by a user (N≥1), and equipment basic information and technical documents (e.g., electronic document file, drawing, operation manual, etc.) may be secured by selecting target equipment and providing additional information. Herein, upon information searching/classifying/storing, equipment-related information in a document may be extracted and structured utilizing a natural language processing function based on a large-capacity data-based language understanding and generation model, and for example, equipment specification information may be structured in a form including extract_specifications(document data)->{“power”:“220V”, “weight”:“120 kg”}.

Furthermore, upon extracting data and identifying components, the static data and the dynamic data may be separated by analyzing equipment specifications, operation conditions, maintenance procedures, and sensor signal flows, and upon extracting equipment components, equipment configuration units may be classified according to independence, functionality, replaceability, and connectivity criteria, and mapped to a predefined ontology or a classification system. Furthermore, upon generating and adding a machine learning model, a learning feature may be recommended or an input variable configuration may be automated based on an analyzed scenario, and for example, it may be utilized in a form including “recommended input variable”: [cycle_time, vibration, motor_temp].

In the EBC component deriving operations 3070, 4070, a state entry, maintenance, and exit operation may be defined by analyzing a flow of a document including an operation manual, and a state transition condition and external interface information may be derived, and for example, a state machine structure may be generated in a method including generate_state_machine(document_text)->{states: [ . . . ], transitions: [ . . . ]}. Thereafter, the processor may determine 4001 whether adding an ML model is necessary, determine 4002 whether information supplementation or additional information is required, and, if necessary, generate and add 4003 the ML model or repeatedly update information through document reanalysis or prompt supplementation.

Furthermore, in the EBC template/item generating operations 3080, 4080, template generation is repeatedly performed according to the set number of generation purposes (N), and in the EBC template or item generating operation, a property set, a behaviour, and interface information may be configured according to each purpose (performance analysis, prediction, optimization, etc.). Thereafter, whether a generation purpose component is satisfied is determined 4004, and if satisfied, then generation, execution, and verification of the EBC instance are performed 4090, and the generated instance may be executed in a simulation, digital twin, testbed, or actual control environment. Furthermore, an execution log analysis may also be performed through large-capacity data-based language understanding and generation model-based analysis.

Finally, whether all generation purposes are satisfied is determined 4005 to terminate the processing flow if all purposes are satisfied, and if not satisfied, then template generation and instance generation procedures for a next generation purpose may be repeatedly performed 4006.

Meanwhile, the “module” or “unit” used in the present specification includes a functional unit implemented in hardware, software, or firmware, may be implemented in the form of logic, a logic block, a circuit, or a program code, and means a minimum unit or a part thereof performing one or more functions. In one embodiment, the module may be implemented in the form of an Application-Specific Integrated Circuit (ASIC), but is not limited thereto.

Meanwhile, according to an embodiment, a computer program stored in a non-transitory computer readable storage medium includes at least one instruction for causing the processor of the computing device to perform each operation included in the method for generating the reusable modular equipment behaviour catalogue according to the above-described embodiments.

Furthermore, according to an embodiment, a non-transitory computer readable storage medium storing a computer program includes at least one instruction in the computer program for causing the processor of the computing device to perform each operation included in the method for generating the reusable modular equipment behaviour catalogue according to the above-described embodiments.

As described so far, according to an embodiment, a reusable equipment behaviour catalogue in various manufacturing simulation environments and virtual production systems may be provided by systematically structuring behaviour information including an operation condition, a state transition, a functional execution procedure, and an external interface of equipment, and configuring them on a module-by-module basis.

Accordingly, an accurate representation of the equipment operation is enabled and the reliability of the simulation may be improved by extracting the behaviour information of the equipment by dividing the behaviour information into the static data and the dynamic data, and deriving the state, the state transition, and the interface based thereon.

Furthermore, an expandable and flexible model configuration is enabled for various equipment and process environments by subdividing the components of the equipment based on independence, functionality, replaceability, and connectivity criteria and modularizing them.

Furthermore, since the equipment behaviour information may be efficiently generated by collecting, analyzing, and classifying various forms of equipment-related information including equipment-related data, time and cost may be reduced compared to the conventional method depending on manual work.

Furthermore, since the equipment behaviour catalogue may be generated in the form of a template and an instance and utilized in various execution environments, the efficiency and consistency of equipment modeling and simulation construction may be improved.

Furthermore, the generated equipment behaviour catalogue may be utilized for productivity prediction, process optimization, and maintenance strategy establishment by being applied to the digital twin, the virtual commissioning, and the production process simulation environments.

Furthermore, since the equipment behaviour information may be selectively combined or reconfigured through the modular structure, a rapid response to various scenarios and a system integration become easy.

Combinations of each operation of each flowchart attached to the present disclosure may be performed by computer program instructions. Since these computer program instructions may be mounted on a processor unit of a general-purpose computer, a special-purpose computer, or other programmable data processing equipment, the instructions executed through the processor unit of the computer or other programmable data processing equipment create means for performing functions described in each operation of the flowchart. The computer program instructions may also be stored in a computer-usable or non-transitory computer-readable storage medium operable to orient a computer or other programmable data processing equipment to implement a function in a specific manner, and thus the instructions stored in the computer-usable or non-transitory computer-readable storage medium may produce a manufactured item containing an instruction means performing the function described in each operation of the flowchart. The computer program instructions may also be mounted on a computer or other programmable data processing equipment, and thus the instructions executing the computer or other programmable data processing equipment may provide operations for executing the functions described in each operation of the flowchart by creating a computer-executed process by performing a series of operation sequences on the computer or other programmable data processing equipment.

Furthermore, each operation may represent a part of a module, a segment, or a code including one or more executable instructions for executing specified logical function(s). In addition, it should be noted that in some alternative embodiments, functions mentioned in the operations may occur out of order. For example, two operations illustrated in succession may actually be performed substantially at the same time, or the operations may sometimes be performed in a reverse order according to a corresponding function.

The above description is merely an exemplary description of the technical spirit of the present disclosure, and various modifications and variations may be made by those having ordinary skill in the technical field to which the present disclosure belongs without departing from an essential quality of the present disclosure. Therefore, the embodiments disclosed in the present disclosure are not intended to limit the technical spirit of the present disclosure but to describe the technical spirit of the present disclosure, and the scope of the technical spirit of the present disclosure is not limited by these embodiments. The protection scope of the present disclosure should be interpreted by the claims below, and all technical spirits within a scope equivalent thereto should be interpreted as being included in the scope of rights of the present disclosure.

What is claimed is:

1. A apparatus for generating a reusable modular equipment behaviour catalogue comprising:
a processor; and
a memory storing instructions executed by the processor,
wherein the processor, by executing the instructions,
collects behaviour information including an operation condition, a state transition, and a functional execution procedure of equipment,
extracts the behaviour information by separating the behaviour information into static data and dynamic data,
derives a state, the state transition, and an external interface of the equipment based on the static data and the dynamic data,
structures the behaviour information including the derived state, the state transition, and the external interface on a module-by-module basis, and
generates a reusable Equipment Behaviour Catalogue (EBC) by combining the structured behaviour information.

2. The apparatus of claim 1, wherein the processor sets a generation purpose of the equipment behaviour catalogue, and determines a collection range and a structuring method of the behaviour information according to the generation purpose.

3. The apparatus of claim 1, wherein the processor collects identification information of target equipment and access information on related technical documents, and searches, classifies, and stores equipment-related information from a plurality of heterogeneous data based on the access information.

4. The apparatus of claim 3, wherein the heterogeneous data includes at least one of a document file, an image file, a video file, an audio file, a 3D model file, a control program file, and a data file.

5. The apparatus of claim 1, wherein the static data includes physical specifications, an installation condition, and an environmental condition of the equipment, and the dynamic data includes an operation procedure, a state transition condition, an input/output signal, maintenance information, and anomaly response information.

6. The apparatus of claim 1, wherein the processor defines components constituting the equipment on a module-by-module basis by subdividing the components based on independence, functionality, replaceability, and connectivity criteria.

7. The apparatus of claim 1, wherein the state includes a state entry operation, a state maintenance operation, and a state exit operation, and the state transition includes a starting state, an arrival state, and a transition condition.

8. The apparatus of claim 1, wherein the external interface includes a signal direction, identification information of connected equipment, and an interface type.

9. The apparatus of claim 8, wherein the processor generates an EBC template or item including a property set, a behaviour, and the external interface based on the structured behaviour information.

10. The apparatus of claim 9, wherein the EBC template or item is represented in a structured data representation format or a standard metamodel format for a digital representation of an asset.

11. The apparatus of claim 9, wherein the processor generates an executable EBC instance based on the EBC template or item, and executes and verifies the EBC instance in a simulation environment or an actual operation environment.

12. The apparatus of claim 1, wherein the processor utilizes one or more information processing techniques to extract the behaviour information from equipment-related data.

13. The apparatus of claim 1, wherein the processor determines whether an EBC generation purpose is satisfied, and reconfigures the equipment behaviour catalogue by repeatedly performing a data extraction operation and a component derivation operation when he EBC generation purpose is not satisfied.

14. The apparatus of claim 1, wherein the processor applies a function calling method and a structured data generation technique using a large language model to extract the behaviour information of the equipment from equipment-related data.

15. The apparatus of claim 1, wherein the processor incorporates an output result of a machine learning model for a failure prediction, an anomaly detection, or a maintenance time prediction into a state transition condition or the dynamic data.

16. The apparatus of claim 1, wherein the processor executes a generated EBC instance in at least one of a simulation environment and an actual operation environment, and verifies suitability of a state transition and an interface operation based on an execution result.

17. A method for generating a reusable modular equipment behaviour catalogue performed by a computing device, the method comprising: collecting behaviour information of equipment; extracting the behaviour information by separating the behaviour information into static data and dynamic data; deriving a state, a state transition, and an external interface based on the static data and the dynamic data; structuring the derived information into modules; and
generating a reusable equipment behaviour catalogue by combining the modules.

18. The method of claim 17, wherein the method further comprises subdividing components of the equipment based on independence, functionality, replaceability, and connectivity criteria.

19. The method of claim 17, wherein the method further comprises generating a plurality of EBC templates according to a plurality of generation purposes, and repeatedly generating and verifying an EBC instance corresponding to each of the EBC template.

20. A non-transitory computer-readable storage medium storing a computer program, wherein the computer program, when executed by a processor, causes the processor to perform a method for generating a reusable modular equipment behaviour catalogue comprising: collecting behaviour information of equipment; extracting the behaviour information by separating the behaviour information into static data and dynamic data; deriving a state, the state transition, and an external interface based on the static data and the dynamic data; structuring derived information into modules; and generating a reusable equipment behaviour catalogue by combining themodules.
